(19) United States
(12) Patent Application Publication
(10) Pub. No.: US 2002/0078028 A1
(43) Pub. Date: Jun. 20, 2002

(54) Network server

(75) Inventor: Robert J. Lisanke, Petaluma, CA (US)

Correspondence Address: ELMER GALBI, 13314 VERMEER DRIVE, LAKE OSWEGO, OR, 97035

(73) Assignee: Trevalon Inc., Petaluma, CA (US)

(21) Appl. No.: 10/017,890

(22) Filed: Dec. 14, 2001

Related U.S. Application Data
(60) Provisional application No. 60/256,446, filed on Dec. 18, 2000.

(51) Int. Cl. G06F 7/00

(52) U.S. Cl. 707/1

(57) ABSTRACT

An event-driven system that that provides scheduling and resource allocation for an internet serve. A cost-benefit model and user preferences are used to prioritize and schedule tasks. The present invention improves or optimizes a network server's performance by prioritizing tasks according to their importance, cost, and the system owners desires. The tasks are scheduled and resources (for example memory) are allocated to the tasks in accordance with their priority. Interlayer communication is used to provide a faster way to move data and to provide feedback as to the current state of a particular layer. Header parsing and peeking provides a way to make decisions earlier rather than waiting for the necessary information to bubble up to a higher layer. A thin thread model is used to handle tasks. The progress of the thin threads relative to each other is monitored and controlled.

### FIELD OF THE INVENTION

The present invention relates to communication systems and more particularly to networked servers.

### BACKGROUND

Multi-processing, that is, simultaneously handling multiple tasks by periodically switching between a number of different tasks, is common in modern day computer systems and in network servers. There is a large body of literature relating to interrupt handling and to prioritize different tasks. However, in existing network servers the user has little if any control over the prioritization of the individual tasks which the server performs in responding to different types of specific requests that the server receives. Version 6 of the IP protocol does have a priority field; however, the purpose of this field is to prioritize the transmission of packets through the internet routers, rather than prioritizing tasks inside the server.

### SUMMARY OF THE PRESENT INVENTION

The present invention provides an event-driven system that that provides scheduling and resource allocation for an internet server. The present invention utilizes a cost-benefit model and user preferences to prioritize and schedule tasks. A network server's performance is improved by prioritizing tasks according to their importance, cost, and the system owners desires. The tasks are scheduled and resources (for example memory) are allocated to the tasks in accordance with their priority. Interlayer communication is used to provide a faster way to move data and to provide feedback as to the current state of a particular layer. Header parsing and peeking provides a way to make decisions earlier rather than waiting for the necessary information to bubble up to a higher layer. A thin thread model is used to handle tasks. The progress of the thin threads relative to each other is monitored and controlled.

### BRIEF DESCRIPTION OF THE FIGURES

FIG. 1 is a system block diagram showing the organization of a first embodiment of the present invention.

FIG. 2 is a programming block diagram that illustrates the operation of the system.

FIG. 3 illustrated an HTTP request which is processed by the present invention.

### DETAILED DESCRIPTION

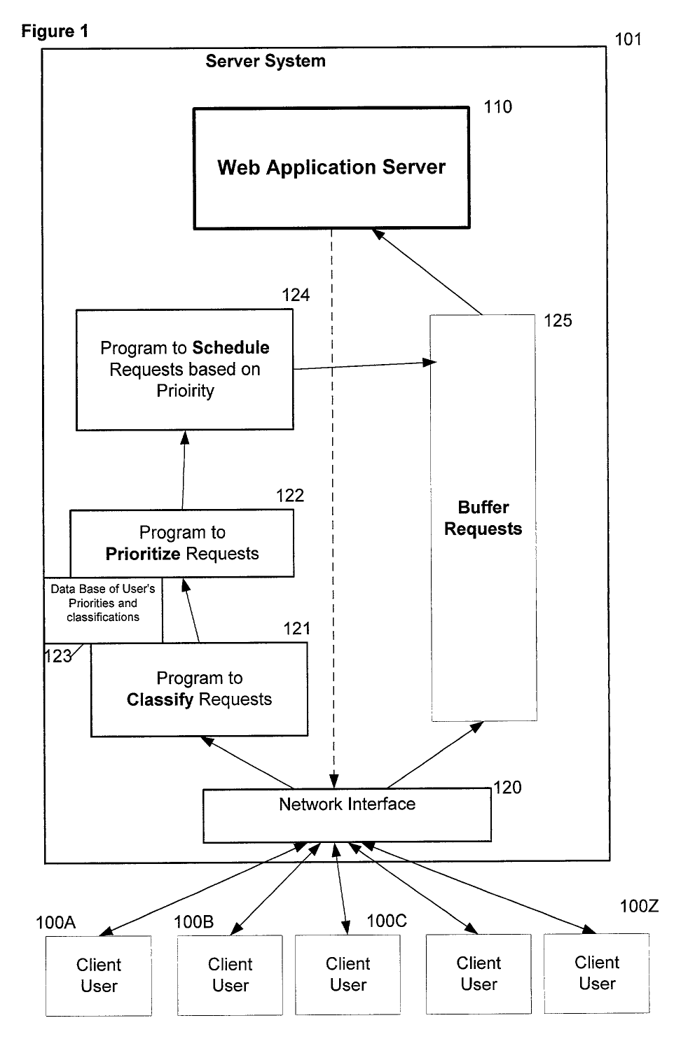

The first embodiment includes number of clients 100A to 100Z that are connected to a server system 101 via the Internet. The clients 100A to 100Z may for example be personal computers with may the Microsoft Windows operating system and a browser connected to the internet via dial-up, DSL or cable modems. While only five such client systems 100A to 100Z are specifically shown in FIG. 1, it should be understood that there may be hundreds or even thousands of such client machines accessing a particular server 101 through the internet at a particular time. Only five are shown in FIG. 1 for convenience of illustration. The figures is intended to illustrate that there are a large number of client machines sending requests to a server system 101.

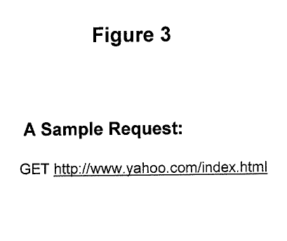

The server system 101 includes a web application server 110 (which in fact may consist of multiple servers) that respond to the requests from clients 100A to 100Z. The web application server can be any of type of web server such as those that are accessible from the internet. For example the web application server 110 can be a network interface to a to a set of programs that generate web pages based on content from a variety of sources. Often in such systems a database is involved. A specific example is the type of web server typically used by brokerage companies. Such servers typically have web pages constructed by running a program which uses information from a database which includes account information together with pictures and logos, etc. A conventional net interface 122 receives requests for clients 100A to 100Z and passes them to other programs in the system for further processing. The requests that come from clients 100 can for example be a request such as the example shown in FIG. 3. (Note the request is shown in a FIG. since according to patent office rules, such material can not be included in the specifications). The example shown in FIG. 3 includes the command GET, the protocol identification, in this case “http”, a www server address, in this case “yahoo.com”, followed by the item name index.com. As is well known, various other information can be also be included in such a request.

Each request received by the system is first classified by program 121, the request is then prioritized by program 1122 and finally it is scheduled by program 124. A data base 123 specifies how different types of requests are to be classified. Data base 123 is set up and controlled by the system operator. The data 123 also specifies the cost of each type of request. The cost assigned to each type of request can be a fixed cost specified by the system operator for that type of request or it can be a dynamic type of cost function that takes into account the cost of processing the previous similar request. The classification of each request is done by program 121 according to the specifications and information set out in data base 123. The system owner can change the information in data base 123 from time to time as desired in order to make the system operate in a specific manner. The information in data base can be changed in a conventional manner such as via one of the clients 100A to 100Z which has system administrator privileges.

The classification could for example specify the benefit and cost of each request as follows: A request to order a product might be given a benefit rating of 20, whereas, a request to view a news article might be assigned a benefit rating of 10. Requests from the Company CEO for personnel information may be given a higher benefit rating than requests which come from the accounting department for historical accounting information.

Each request is also classified according to cost: A request to order a product might be assigned a cost of 50 whereas a request to view a news article might be assigned a cost of 20. The costs assigned to a request would take into account such factors as the amount of buffer memory required by the task, the amount of CPU time, the bandwidth requirements.

Given four different requests, they may be classified with cost and benefit parameters by

Request 1: benefit 20 cost 20

Request 2: benefit 20 cost 2

Request 3: benefit 10, cost 3

Request 3: benefit 20 cost 5.

After requests are classified, the are prioritized by program 122. Program 122 implements rules that the system operator stores in data base 123. That is, information in data base 123, specifies how requests are to be prioritized. The rules can be simple or complex. For example, The system owner might simply specify a rule that says: subtract the cost from the benefit and the resulting number is the priority. On the other hand the prioritization can

In this case, users wait an average of only 122.5 milliseconds instead of 242.5, obtained using first-come, first served scheduling. More benefit is delivered sooner, and only less valuable and more costly jobs are delayed. Additionally, a pre-emptive scheduler has the ability, continuously, to insert higher priority jobs in front of lower priority ones. So, with the above scheduling and pre-emptive scheduling, the final, 200-millisecond job may run later than fourth, but it will not run sooner.

The invention can employs well-known techniques for optimization and job scheduling. With the present invention known optimization and job scheduling techniques can be used to provide efficient Web and Internet servers, independent of the particular optimization or scheduling technique used.

Classification can be done as a mathematical function of known and estimated parameters. The above-mentioned benefit value may be a function of many parameters such as: requested URL, client IP address, cookie, login, connection quality and other distinguishing attributes. The cost may be more than just the time required to send or process the request, including, such factors as the required bandwidth, CPU, latency, data generation requirements, and total server load.

In general, the benefit and cost are functions of known and estimated parameters can be described as follows:

Benefit=B(p1, p2, p3 . . . )

Cost=B(p1, p2, p3 . . . ), where pN are known and estimated parameters.

The functions may be tabular, or an actual mathematical function of the parameters or a combination of tabular and arithmetic functions. For example, a system can award points for a desirable URL request, one that is know to encourage commerce, compared to a reference or general information section of the site, which is read by both customers and non-customers.

Order placement=100 points

Browse catalog=20 points

Download reference material=10 points

Points also go to requests that correspond to requesters who are, for example, good customers, as determined by the cookie, login, or, possibly, the IP source address.

Returning customer=+20 points

The connection quality determines how critical a connection is and how noticeable delays will be. This allows re-sequencing non-critical requests behind critical ones. In some cases, a modem user may not notice a slight delay but the DSL user will.

RTT estimate<100 ms, critical, speed sensitive

RTT estimate>100 ms, non-critical

The cost function is usually an estimate of the CPU required to generate the reply, the total time including latency required to generate the reply and the bandwidth required to send the reply back to the client. Other considerations include things such as the need for slots on application and database servers.

For example, a typical response may cost 2 ms CPU, 20 ms latency, and 25 k Bytes of data transfer. In general the optimal scheduler is one that delivers the maximum benefit, subject to the constraints that the total costs are less than the system limits in all cases.

### Example Two

Server connection and load management: A special case of a managed resource is a secondary server, usually an application server or database server. The server may suffer performance problems if its load is too high or if there are too many connections to the server from remote clients.

Typical server response time vs. load

1 pending requests—10 ms avg. response time

5 pending requests—12 ms avg. response time

10 pending requests—20 ms avg. response time

20 pending requests—50 ms avg. response time

100 pending requests—400 ms avg. response time

Here we see that, initially, efficiency increases due to increased concurrency and overlapping of requests that have both a latency (delay) and a processing (CPU) component. After a certain point, the server becomes less efficient due to overhead of maintaining many pending requests. Many application and database servers use operating system threads or processes to handle simultaneous tasks. This results in diminishing returns as threads corresponding to pending requests compete for synchronization primitives and as the operating system is forced to switch back and forth among the outstanding tasks.

In the above example, the server runs most efficiently at a load of around 10 pending requests, 20 ms average response time, for a total of around 500 “hits” per second. If the load is 100, with an average response time of 400 ms, then the throughput is about 250 hits per second. Intelligent load management would maintain the load on the server at 10, while queuing the remaining requests. As described in Example 1, this queuing has the added benefit of being able to order or prioritize the requests within the queue, with additional gains in throughput and reduction of average response time.

With the present invention requests can be handled by an intermediate server/optimizer, which queues the connection and transfers the data back and forth between the requesting client and the origin and application servers.

Net result due to intelligent load management, with 100 pending requests: 500 hits/sec, with an average response time of 20+(2 ms)*90=200 ms, compared with 250 hits/sec and 400 ms average response time with the standard application server.

Often, simply connecting to application and database servers slows the progress of tasks executing on the server. In this case, it is helpful to off-load idle connections to an intermediate server, which handles connection with an efficient queuing and I/O system.

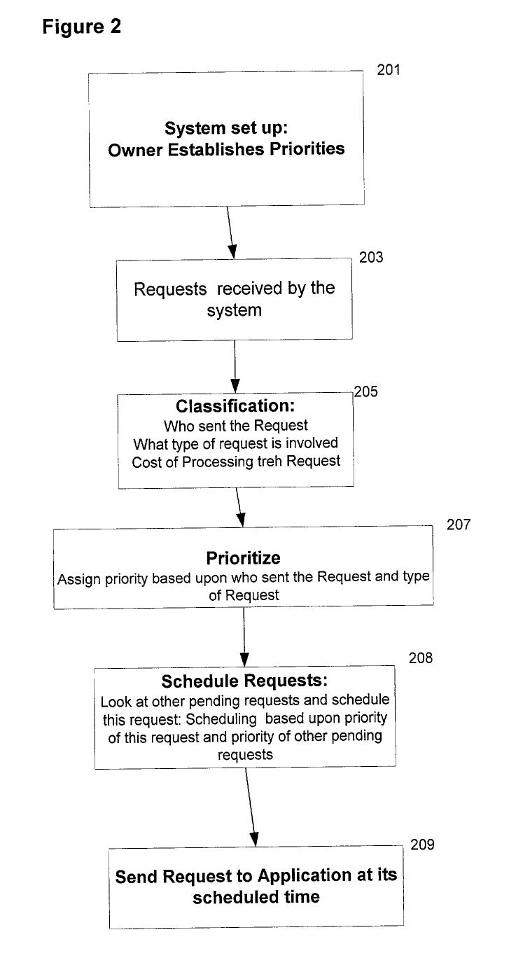

A program flow diagram illustrating the operation of the system is given in FIG. 2. First as indicated by block 201, the owner establishes a set of classifications priorities. These are stored in data base 123. If such a set are not as yet established the system utilizes a default set of priorities and classifications. The system receives requests from clients 100A to 100Z as indicated by block 203.

As indicated by block 295, the requests are classified in accordance with the classifications established by the system owner and stored in data base 123. Next as indicated by block 207, each request is prioritized in accordance with its classifications. Finally as indicated by block 208, the requests are scheduled in accordance with their priorities. Naturally higher priority requests are scheduled to be processes before lower priority requests.

Finally as indicated by block 209 the requests are sent to the web application server 110 and any outgoing traffic is sent to the network interface 120 for dispatch to the client machines 100Ato 100Z.

Program 124 schedules the requests according to their priority and then prioritizes the requests in buffer 125. The requests are sent to the web application server 110 in accordance with their priority. A low priority requests which arrived first may reach web application server 112 after a high priority request which the system received at a later time.

In summary, the system includes programs that classify and priorities requests according to parameters established by the system operator. Different types of requests are provided with different priorities such that high priority requests are acted upon by the web application server 110 before low priority requests. This gives the system operator a great deal of flexibility in arranging the system provide a desired type of performance.

While in the embodiment described above, the classification, prioritization, and scheduling are done by three separate program routines, it should be understand, that the present invention relates to a program and system that performs this combination of functions. Those skilled in the art will realize that these functions can be performed using a wide variety of programming arrangements other than three separate programs.

In one embodiment of the present information, the classification, prioritization and scheduling is done based upon the TCP payload data that is received at the system 101. It is however noted that IP packets generally have the following form: IP header gives source and destination information for routing. TCP header: tells how may bytes in the payload, TCP options, etc. TCP payload: Data bytes that contain a command such as that shown in FIG. 3.

While one embodiment of the present invention operates by classifying, prioritizing and scheduling requests based upon the payload data, alternate embodiments take into account the information in the IP header and TCP header when the system does the classification, prioritization and scheduling.

The above described embodiment of the invention merely improves performance by scheduling the order in which tasks are operated upon by the server. In an alternate embodiment, in addition to scheduling when the tasks will be provided to the server, the amount of resources applied to each task is controlled in accordance with the classification and priority of the task. For example, the amount of memory that the server devotes to each class is controlled in accordance with the classification and priority of the particular task. In such an embodiment, when each request is passed to the server, a control parameter is also passed to the server. The control parameter instructs the server concerning the amount of resources (for example memory) that should be applied to the particular request.

The present invention optimizes CPU usage and network bandwidth while reducing latency and providing feedback to server administrators. This is accomplished by generating a cost-benefit model and optimizing it through request and task prioritization. The invention can be implemented as a custom kernel with a lean thread model further reduces requirements over a standard operating system's general-purpose thread model. Essentially, the custom scheduler and resource allocator take control away from the generic OS, returning it to the server owner. The custom kernel is fully event-driven, responding quickly to common conditions such as data ready or disk I/O complete, as well as to exception conditions like “connection reset by peer” or “address now unreachable”. The kernel layer is designed to conserve system resources, especially RAM, so that the server will function optimally and degrade gracefully. Most systems exhibit non-linear delay vs. load characteristics, with a sharp knee in the curve at a critical load, indicating non-graceful degradation. The present invention will extend the curve by deferring lower priority and “housekeeping” tasks and by using system resources more efficiently.

The cost-benefit model enables prioritization of requests by content (URL) or requester (IP address, login, cookie), as well as according to more automatic criteria such as content length, resource requirements, or end-to-end connection quality. For example, if the server has one large request and ten small requests it may wish to service the ten small requests first, satisfying ten users, while adding an acceptable delay to the large request. Furthermore, shaving 100 milliseconds off a 200 millisecond RTT (round trip time) task would result in noticeable increase in interactivity. However, shaving 100 milliseconds off a 600-millisecond modem connection would not even be appreciated. This targeted, fine-grain optimization is enabled by characterizing the requests, estimating their resource requirements, then queuing up the required tasks in the correct sequence to optimize the model.

A server in accordance with the present invention improves efficiency by performing resource allocation and scheduling according to a cost-benefit model that is established both automatically and by the server's administrator. Requests to the server may be classified according to URL, URL parameters, requester, connection quality, content size and generation requirements, server required, time of day, or any other identifying characteristic.

Each class of request may have its own priority level, benefit, maximum or weighted proportional share of total bandwidth, maximum or weighted proportional share of an assigned CPU, or priority of access to any system resource, server, or storage device.

Each class may have deadlines or constraints on delivery, with variable penalties for lateness and dropping. External, user objectives and constraints are translatable to internal constraints, which determine CPU and bandwidth scheduling and proportional share at the segment (packet) granularity.

With the present invention, a custom stack can schedules packet (segment) departure based on deadlines and lateness penalties that have been established by the scheduler and allocator.

The invention utilizes an event-driven framework. A custom OS layer which manages the classification, prioritization and scheduling reduces the overhead of the general-purpose OS in the server, and it provides better communication between multiple, simultaneous tasks that are in progress. The custom OS layer maps multiple request/reply tasks to fewer threads or a single thread of the host OS.

The custom OS layer uses knowledge of continuations and non-blocking activities, cooperative multi-tasking based on a trust relationship between tasks is enabled. This is similar to the technique that is often used in the design of simulators. Such techniques reduce the overhead of multiprogramming a large number of independent tasks. Monitoring or a “pulse function” detects blocked or deadlocked processes to transfer workload to other, functioning processes, of which, new server OS instances may be added as needed.

A customized protocol stack can reduce the cost of open connections that have no assigned or discernible pending tasks. Such connections store only a source address and port without the usual socket resources. This stack may run in parallel with the existing TCP/IP stack by intercepting relevant ports, protocols, and URL requests at the kernel level, affording them special treatment.

The present invention eliminates network layer overhead. The custom stack also provides feedback to the scheduler and allocator regarding connection quality and available TCP and IP resources. Similarly, the custom stack greatly reduces the cost of servicing in-memory “cached” replies by forgoing the need for creating “socket” resources to grant access of kernel data to user spaces.

The custom stack may multiplex multiple connections and data transfers “on the wire” and at the network layer into a single user-level connection at the OS-user/application layer.

With the present invention, customized applications replace the layered network interface with interprocess communication (i.e. IPC) and remote procedure calls (i. e. RPC) to communicate directly with the system more efficiently.

One valuable by-product of peeking into the TCP layer to glean connection information is the ability to provide the server owner with more detailed traffic statistics. The server statistics and quality of achieving the user-defined and automatic criteria is fed-back to a monitoring and reporting application, which then displays said information to the administrator.

In conclusion: The present invention provides an event-driven custom kernel for a server. The custom kernel provides scheduling and resource allocation. The custom kernel operates in accordance with a cost-benefit model which is optimized by request and task prioritization. The cost-benefit model prioritizes requests by content (URL or requester (IP address, login, or cookies) as well as according to criteria such as content length, resource requirements, or end-to-end connection quality. Tasks are classified and prioritized before being run on the CPU. Bandwidth is regulated and data departure is scheduled according to task and server specific criteria that can be established by a user. Fine-grain optimization is achieved by characterizing the requests, estimating their resource requirements, then queuing up the required tasks in the correct sequence to optimize the model. Several types of Interprocess communication (i.e. IPC) and remote procedure calls (i.e. RPC) are used to efficiently communicate directly with the system. These include providing feedback information between layers, and sending data directly from an internal layer to a receiver that is not an adjacent layer via inter-process communication. Since the kernel in the server obtains information from the TCP and IP layers, detailed traffic statistics can be provided to the server owner.

While the invention has been shown and descried with respect to preferred embodiments thereof, it will be understood by those skilled in the art, the various changes in form and detail can be made without departing from the spirit and scope of the present invention. The invention is limited only by the appended claims.

I claim:

1) a system for processing requests provided to a web or application server comprising,
a computer program for assigning cost and benefit values to requests received by said system,
a computer program for prioritizing said requests in accordance with the assigned cost and benefit values, and
a computer program for scheduling said requests in accordance with the assigned priorities, whereby said requests are not necessarily processed in a first come fist served basis.

2) A method of scheduling the order that requests are sent to a web application server comprising,
classifying and assigning each request received by said web application server cost and benefit value,
prioritizing said requests according to said assigned cost and benefit values,
scheduling said requests based upon the assigned priority such that requests are not necessarily processed on a first come first serve basis.

3) The system recited in claim 1 wherein the origin of a request is considered when assigning a priority to said packet.

4) The method recited in claim 2 wherein the origin of a request is considered when assigning a priority to said packet.

5) The system recited in claim 1 wherein said requests are classified and prioritized in accordance with parameters established by a system operator.

6) The method recited in claim 2 wherein said requests are classified and prioritized in accordance with parameters established by a system operator.

7) The system recited in claim 1 wherein said requests are classified and prioritized in accordance with the payload data in requests received by said system.

8) The method recited in claim 2 wherein said requests are classified and prioritized in accordance with the payload data in requests received by said system.

9) The system recited in claim 1 wherein said requests are classified and prioritized in accordance with both the payload data in requests received by said system and with in the packet headers of such requests.

10) The method recited in claim 2 wherein said requests are classified and prioritized in accordance with the payload data in requests received by said system and with in the packet headers of such requests.

11) A system for servicing requests sent to a web server which includes, buffering said requests, classifying and prioritizing said requests in accordance with specified criteria, scheduling said requests for action by said web server in accordance with the classification and priorities of said requests, whereby requests sent to said web server are operated upon in a sequence specified by said criteria.

12) The method in claim 11 wherein a system operator establishes said criteria weherby said system operator can control the priority that requests sent to said server are processed.

13) The method recited in claim 11 wherein said requests are sent to said server over the Internet.

14) The method recited in claim 11 wherein resources in said web server are assigned to requests based upon the priority and classification of said requests.
